(19) United States
(12) Patent Application Publication
(10) Pub. No.: US 2026/0181347 A1
(43) Pub. Date: Jun. 25, 2026

(54) SPATIAL AUDIO SIGNALS

(71) Applicant: Nokia Technologies Oy, Espoo (FI)

(72) Inventors: Lasse Juhani LAAKSONEN, Tampere (FI); Miikka Tapani VILERMO, Tampere (FI); Arto Juhani LEHTINIEMI, Tampere (FI)

(21) Appl. No.: 19/335,096

(22) Filed: Sep. 22, 2025

(30) Foreign Application Priority Data
Sep. 26, 2024 (GB) 2414131.9

(51) Int. Cl. H04S 7/00

(52) U.S. Cl. CPC H04S 7/303

(57) ABSTRACT

Examples of the disclosure relate to spatial audio signals for telecommunication sessions. A spatial audio signal is provided where the spatial audio signal represents an audio scene. Spatial metadata corresponding to the spatial audio signal is also provided. Auxiliary audio signals are provided where the auxiliary audio signals represent the audio scene and have been processed using a process different to a process used for the spatial audio signal. An indication that the spatial metadata corresponding to the spatial audio signal can be reused for the auxiliary audio signals is also provided.

### TECHNOLOGICAL FIELD

Examples of the disclosure relate to spatial audio signals. Some relate to spatial audio signals for telecommunication sessions.

### BACKGROUND

Participants in telecommunication sessions can be located in a variety of environments. For example, participants could be in quiet environments such as offices or homes or could be in noisy environments such as busy streets or sports arenas. The codecs used for audio signals in these communication sessions need to be robust for the different types of environments.

### BRIEF SUMMARY

According to various, but not necessarily all, examples of the disclosure there is provided an apparatus comprising means for:
providing a spatial audio signal where the spatial audio signal represents an audio scene;
providing spatial metadata corresponding to the spatial audio signal;
providing auxiliary audio signals where the auxiliary audio signals represent the audio scene and have been processed using a process different to a process used for the spatial audio signal; and providing an indication that the spatial metadata corresponding to the spatial audio signal can be reused for the auxiliary audio signals.
The different process used for the auxiliary audio signals can comprise a different type of processing to the process used for the spatial audio signal.

The different process used for the auxiliary audio signals comprises a different amount of processing to the process used for the spatial audio signal.

The process used for the auxiliary audio signals can comprise at least one of:
noise reduction;
wind noise reduction; or
audio focusing.

The auxiliary audio signals may be provided in response to a trigger event wherein the trigger event comprises at least one of:
receiving a request for the auxiliary audio signals from a receiving device; or
determining that one or more trigger conditions are satisfied.

The indication may comprise one or more adjustment parameters indicative of adjustments to be made to the spatial metadata for use with the auxiliary audio signals.

The indication may be provided as at least one of:
a processing information data frame; or
part of a bitstream.

The means may be for providing multiple auxiliary audio signals wherein respective auxiliary audio signals are processed using different processes.

Different auxiliary audio signals may be provided for different participants in a telecommunication session.

The spatial audio signal and the spatial metadata may be provided by a first encoder and the auxiliary audio signals are provided by a second encoder.

The spatial audio signal may be provided as a metadata-assisted spatial audio signal.

The auxiliary audio signals may be provided as at least one of:
stereo audio signal; or
mono audio signal.

The spatial audio signal and the spatial metadata and the auxiliary audio signals and the indication may be provided in a shared bitstream.

The apparatus may be comprised within at least one of:
an audio capturing device; or
a telecommunications server.

According to various, but not necessarily all, examples of the disclosure there is provided a method comprising:
providing a spatial audio signal where the spatial audio signal represents an audio scene;
providing spatial metadata corresponding to the spatial audio signal;
providing auxiliary audio signals where the auxiliary audio signals represent the audio scene and have been processed using a process different to a process used for the spatial audio signal; and
providing an indication that the spatial metadata corresponding to the spatial audio signal can be reused for the auxiliary audio signals.

According to various, but not necessarily all, examples of the disclosure there is provided a computer program comprising instructions which, when executed by an apparatus, cause the apparatus to perform:
providing a spatial audio signal where the spatial audio signal represents an audio scene;
providing spatial metadata corresponding to the spatial audio signal;
providing auxiliary audio signals where the auxiliary audio signals represent the audio scene and have been processed using a process different to a process used for the spatial audio signal; and
providing an indication that the spatial metadata corresponding to the spatial audio signal can be reused for the auxiliary audio signals.

According to various, but not necessarily all, examples of the disclosure there is provided an apparatus comprising means for:
receiving a spatial audio signal where the spatial audio signal represents an audio scene;
receiving spatial metadata corresponding to the spatial audio signal;
receiving auxiliary audio signals where the auxiliary audio signals represent the audio scene and have been processed using a process different to a process used for the spatial audio signal;
receiving an indication that the spatial metadata corresponding to the spatial audio signal can be reused for the auxiliary audio signals; and
rendering the auxiliary audio signals using the spatial metadata corresponding to the spatial audio signal.

The apparatus may further comprise means for sending a request for the auxiliary audio signals to an encoding device.

The request may be sent in response to detecting a user input.

The indication may comprise one or more adjustment parameters indicative of improvements to be made to the spatial metadata for use with the auxiliary audio signals and the means are for applying the improvements to the spatial metadata corresponding to the spatial audio signal and using the adjusted spatial metadata to render the auxiliary audio signals.

The apparatus may be comprised within at least one of:
an audio rendering device; or
a telecommunications server.

According to various, but not necessarily all, examples of the disclosure there is provided a method comprising:
receiving a spatial audio signal where the spatial audio signal represents an audio scene;
receiving spatial metadata corresponding to the spatial audio signal;
receiving auxiliary audio signals where the auxiliary audio signals represent the audio scene and have been processed using a process different to a process used for the spatial audio signal;
receiving an indication that the spatial metadata corresponding to the spatial audio signal can be reused for the auxiliary audio signals; and
rendering the auxiliary audio signals using the spatial metadata corresponding to the spatial audio signal.

According to various, but not necessarily all, examples of the disclosure there is provided computer program comprising instructions which, when executed by an apparatus, cause the apparatus to perform:
receiving a spatial audio signal where the spatial audio signal represents an audio scene;
receiving spatial metadata corresponding to the spatial audio signal;
receiving auxiliary audio signals where the auxiliary audio signals represent the audio scene and have been processed using a process different to a process used for the spatial audio signal;
receiving an indication that the spatial metadata corresponding to the spatial audio signal can be reused for the auxiliary audio signals; and
rendering the auxiliary audio signals using the spatial metadata corresponding to the spatial audio signal.

According to various, but not necessarily all, embodiments there is provided an apparatus comprising
at least one processor; and
at least one memory including computer program code;
the at least one memory storing instructions that, when executed by the at least one processor, cause the apparatus to perform at least a part of one or more methods described herein.

According to various, but not necessarily all, embodiments there is provided an apparatus comprising means for performing at least part of one or more methods described herein. The description of a function and/or action should additionally be considered to also disclose any means suitable for performing that function and/or action. Functions and/or actions described herein can be performed in any suitable way using any suitable method.

According to various, but not necessarily all, embodiments there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all the features described in respect of other examples of the disclosure, and vice versa. Also, it is to be appreciated that any one or more or all the features, in any combination, may be implemented by/comprised in/performable by an apparatus, a method, and/or computer program instructions as desired, and as appropriate. The description of a function should additionally be considered to also disclose any means suitable for performing that function

### BRIEF DESCRIPTION

Some examples will now be described with reference to the accompanying drawings in which:

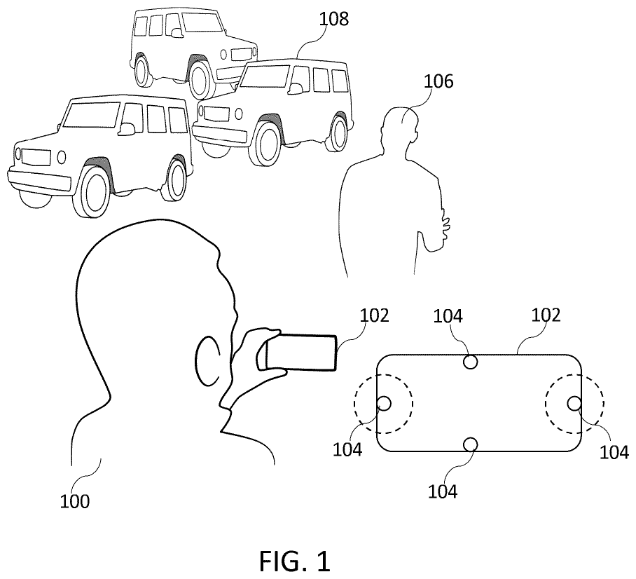

FIG. 1 shows an example use case scenario;

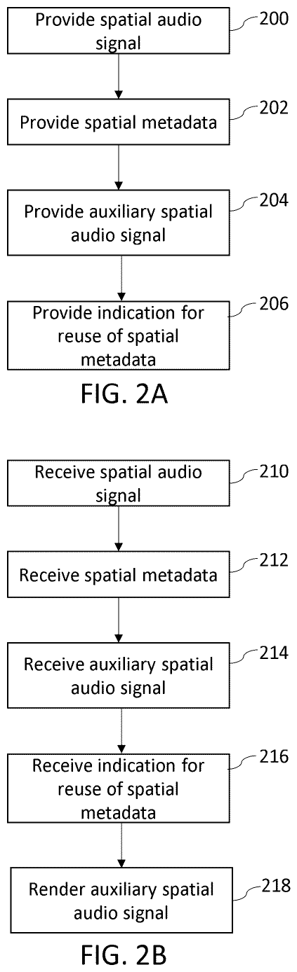

FIGS. 2A and 2B show example methods;

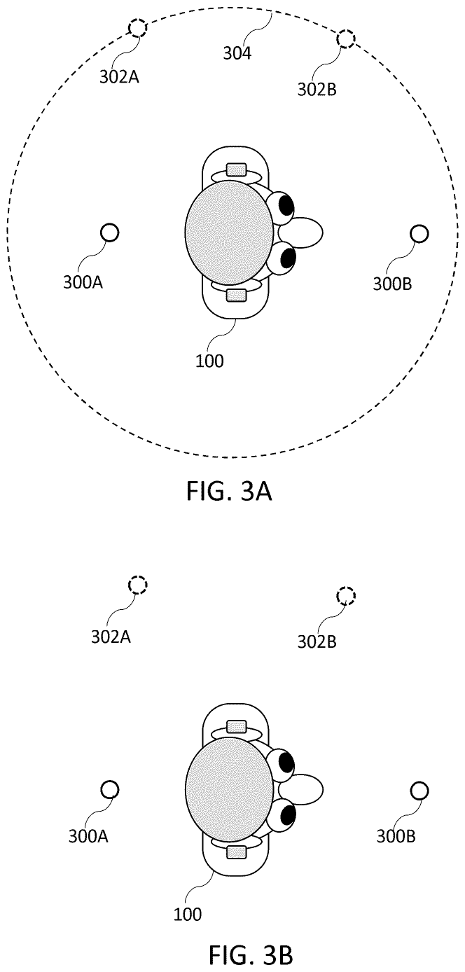

FIGS. 3A and 3B show example use case scenarios;

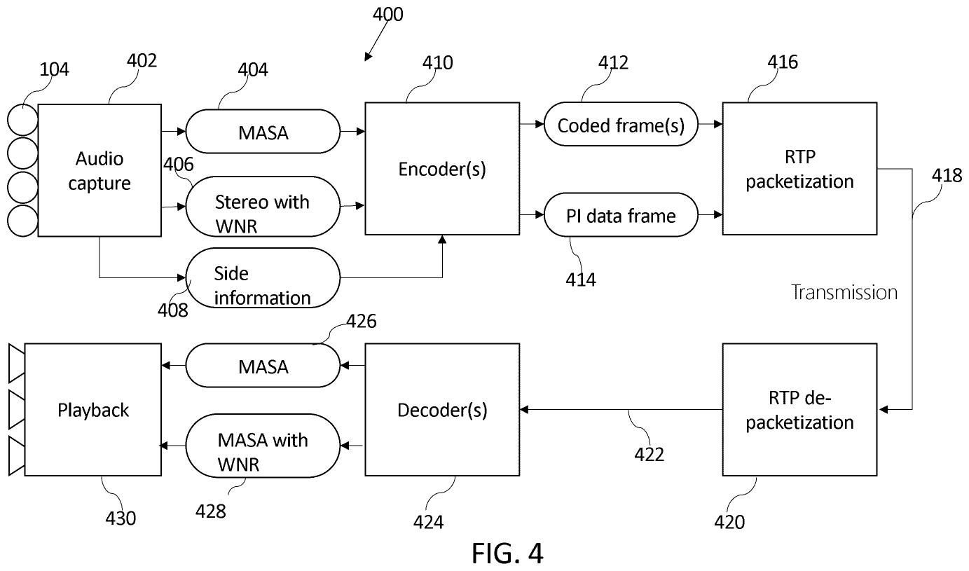

FIG. 4 shows an example system;

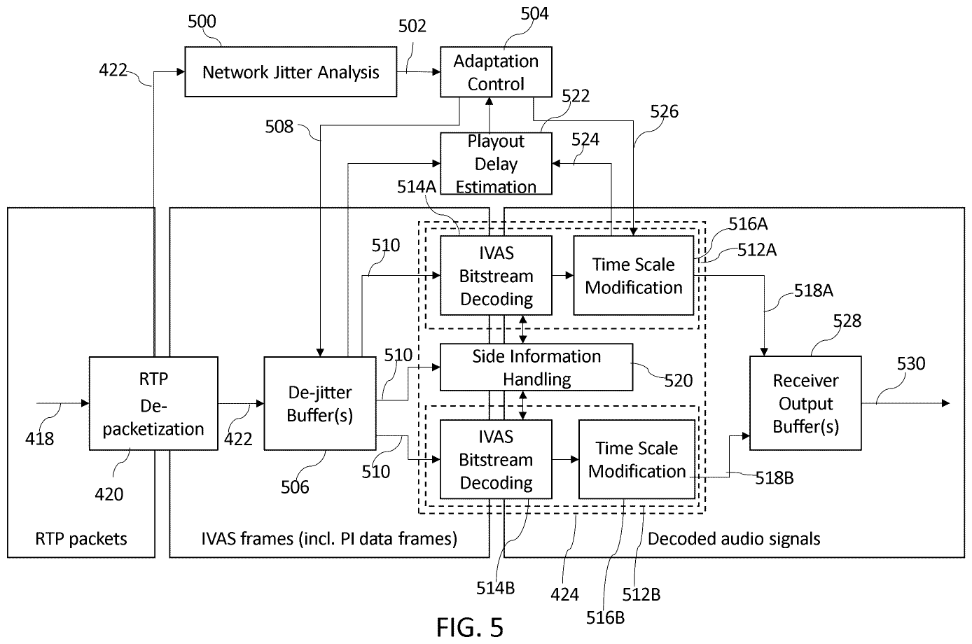

FIG. 5 shows an example decoder; and

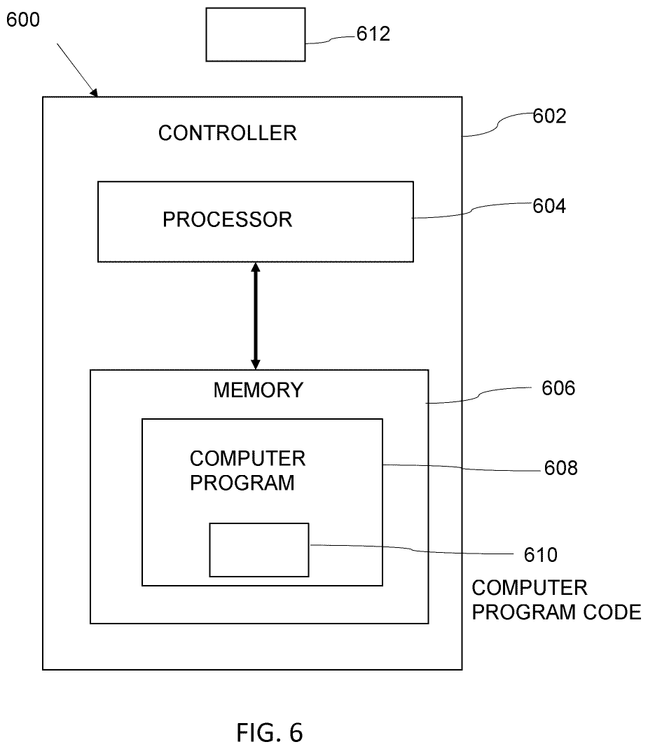

FIG. 6 shows an example apparatus.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Corresponding reference numerals are used in the figures to designate corresponding features. For clarity, all reference numerals are not necessarily displayed in all figures.

### DETAILED DESCRIPTION

FIG. 1 shows a participant 100 in an example telecommunication session. The participant 100 is a person who is using a participant device 102 to communicate in the telecommunication session. The participant device 102 can be used to capture an audio scene and enable audio signals representing the audio scene to be sent to other participants in the telecommunication session. The participant device 102 can also be used to receive audio signals from other participants and enable these to be played back to the participant 100.

The other participants in the telecommunication session are not shown in FIG. 1. The other participants can be located remotely from the participant 100 and the audio signals between the respective participant devices can be exchanged via any suitable communication network. The communication network could comprise a wired and/or wireless network.

The participant device 102 can comprise any suitable type of device. The participant device 102 could comprise a teleconferencing device, mobile telephone, personal computer or any other suitable type of device that can be configured to capture spatial audio and provide playback of audio signals to the participant 100.

The participant device 102 can comprise multiple microphones 104. The microphones 104 are distributed in the participant device 102 so as to enable spatial audio signals to be captured by the participant device 102. In some examples the signals from two or more of the microphones 104 can be selected as transport channels for the audio signals from the participant device 102.

In FIG. 1 the spatial audio signals that are captured by the microphones 104 represent the audio scene in which the participant device 102 is located. The audio scene can comprise the participant 100 and also background noise or other incidental noise from the environment around the participant 100. In the example of FIG. 1 the participant 100 is located in a busy street. This causes a lot of background noise to be captured as part of the audio scene.

The audio scene comprises the participant 100 talking and also other sounds from the busy street such as people 106 who are in the same location as the participant 100 but who are not using the participant device 102 or part of the telecommunication session, noise from the traffic 108 or other background noises. Some of the background noise could be detected directionally by the participant device 102. For example, a car horn or an engine revving or talking by a person 106 could be detected as coming from a particular direction. Some of the background noise could be detected as ambient or diffuse, that is, not associated with any specific direction. Other background noises could also be detected such as wind noise, which is not shown in FIG. 1.

The participant device 102 can comprise an apparatus such as a controller or processor that can process the microphone signals to provide spatial audio in a format that is suitable for use in the telecommunication session. For example, the participant device 102 can provide spatial audio signals and associated metadata in a Metadata-Assisted Spatial Audio (MASA) format that is suitable for use with a 3GPP Immersive Voice and Audios Services (IVAS) codec, or could use any other suitable format and/or codec. For example, in the scenario of FIG. 1 a stereo-MASA signal could be used. The stereo-MASA signal can comprise two transport audio channels and corresponding spatial metadata.

The spatial audio from the participant device 102 can be transmitted to one or more other participant devices in the telecommunication session. Different participants in the telecommunication session might have different preferences or requirements with regards to the background noises. Similarly, the same participant could have different preferences or requirements at different times during a telecommunication session. The preferences or requirements could be based on factors such as the type of playback devices that are used. For example, a participant with high quality playback devices might want to hear all of the background noise as this could provide a pleasant ambient effect. In the example of FIG. 1 a receiving participant might want to retain the background noise from the traffic 108 and people 106 as this might contribute to the overall ambience of the audio they are listening to.

In some examples the preferences or requirements could be based on factors such as the need to focus on a speaker. For example, a participant who is hard of hearing might struggle to hear a talker if the background noise is too loud. In such cases, receiving participant might want to retain the background noise from the traffic 108 and people 106 shown in FIG. 1 as this might make the participant 100 harder to hear.

Examples of the disclosure can be used to account for the different requirements or preferences in relation to the background noises. This can enable different participants in the same telecommunication session to have different settings for the background noise during the telecommunication session. This can also enable a participant to change a setting for the background noise during the telecommunication session.

FIGS. 2A and 2B show example methods that can be used in examples of the disclosure. The example methods can be implemented using an apparatus such as a controller or any other suitable apparatus. The apparatus could be provided within a participant device 102 or in any other suitable device within the telecommunication network. The methods of FIG. 2A could be implemented by an audio capturing device such as a participant device 102 or a telecommunications server or any other suitable device.

The method comprises, at block 200 providing a spatial audio signal where the spatial audio signal represents an audio scene. The audio scene is the sounds that are captured by the microphones 104 of the participant device 102. The audio scene can comprise sounds from multiple sources. The audio scene can comprise direct sounds that are perceived to arrive from a specific direction. The audio scene can comprise ambient sounds that are not perceived to come from a specific direction.

The spatial audio signal can be provided as a MASA signal, as a stereo-MASA signal or in any other suitable format.

At block 202 the method comprises providing spatial metadata corresponding to the spatial audio signal. The spatial metadata that corresponds to the spatial audio signal represents the same audio scene as the spatial audio signal. The spatial metadata comprises information that can be used to process the spatial audio signals to render spatial audio. The spatial metadata can comprise any suitable information such as directional parameters and energy ratios. The spatial metadata can be provided in frequency bands.

At block 204 the method comprises providing one or more auxiliary audio signals. The auxiliary audio signals represent the same audio scene as the audio signals and the corresponding spatial metadata. The auxiliary audio signals differ from the spatial audio signal in that the auxiliary audio signals have been processed using a process different to a process used for the spatial audio signal.

The different process used for the auxiliary audio signals can comprise a different type of processing to a process used for the spatial audio signal. For example, noise reduction, wind noise reduction, audio focusing, or any other suitable type of processing could be used for the auxiliary audio signals but not for the spatial audio signal.

In some examples the different process used for the auxiliary audio signals can comprise a different amount of processing to a process used for the spatial audio signal. For example, noise reduction (or any other suitable type of processing) can be used at a first level for the auxiliary audio signals and a different level for the spatial audio signal. This can enable the processing to be provided at a higher level for the auxiliary audio signals than for the spatial audio signal or, conversely, the processing could be provided at a higher level for the spatial audio signal.

The processing that is applied to the auxiliary audio signals can reduce or enhance one or more sounds in the audio scene compared to the spatial audio signal. For instance, the processing applied to the auxiliary audio signals could reduce background noise or enhance or otherwise improve the intelligibility of speakers, compared to the spatial audio signal.

The auxiliary audio signals can be provided in response to a trigger event. In some examples the trigger event can comprise receiving a request for the auxiliary audio signal. The request can be received from a receiving device that receives the spatial audio signal and/or any other suitable device within the telecommunication network. The receiving device can be a participant device used by a participant device in the telecommunication session.

The trigger event could be a determination that one or more trigger conditions are satisfied. In some examples the trigger conditions can comprise a determination that one or more conditions are satisfied. The conditions could be background noise levels, the presence of a focusable sound source or object in a certain direction, presence of wind noise, or any other suitable conditions. The trigger condition can be determined by the type of processing that is applied to the auxiliary audio signal. For instance, if the processing that is applied to the spatial audio signal comprises wind noise reduction, then the trigger condition could be based on the presence of wind noise rather than other factors.

As an example, the auxiliary audio signals can be provided if it is determined that the background noise in the audio scene has increased above a predetermined amount. The auxiliary audio signals can be provided for the time period that the conditions are satisfied. The provision of the auxiliary audio signals can then stop if the conditions stop being satisfied. The provision of the auxiliary audio signals could be restarted if the conditions become satisfied again later.

The spatial audio signal and spatial metadata can be provided by a first encoder and the auxiliary audio signal, or the multiple auxiliary audio signals, can be provided by a second encoder.

The one or more auxiliary audio signals can be provided as a stereo audio signal, a spatial audio signal, or a mono audio signal or in any other suitable format.

At block 206 the method comprises providing an indication that the spatial metadata corresponding to the spatial audio signal can be reused for the auxiliary audio signal. The reuse of the spatial metadata means that the spatial metadata can also be used to process the auxiliary audio signals to render spatial audio.

In some examples the spatial audio signal and the spatial metadata and the one or more auxiliary audio signals and the indication are provided in a shared bitstream. This can reduce the overall bitrate compared to having to provide separate metadata for the auxiliary audio signals or can enable the audio signals to be provided with a higher quality at the same bitrate.

The indication can be provided in any suitable format. The indication can be provided as a processing information data frame, as part of a bitstream, or in any other suitable format.

In some examples the indication can comprise information indicative of changes that should be made to the spatial metadata to enable the spatial metadata to be used with the auxiliary audio signal. For instance, the indication could comprise one or more adjustments parameters indicative of improvements or other adjustments to be made to the spatial metadata for use with the auxiliary audio signal. In such examples a module can be provided and used to asses if improvements to the spatial metadata are needed and if so, what those improvements should be.

In some examples of the method shown in FIG. 2A a single auxiliary audio signal is provided. In other examples multiple auxiliary audio signals can be provided. The respective auxiliary audio signals can be processed using different processes. Different ones of the multiple auxiliary audio signals represent the same audio scene and are obtained by applying different processing. For example, a first auxiliary audio signal could be processed to reduce background noise and a second auxiliary audio signal could be processed to reduce wind noise.

The different auxiliary audio signals can be provided for different uses, for example, different auxiliary audio signals are provided for different participants in a telecommunication session or could be used at different times during the telecommunication session.

FIG. 2B shows a method corresponding to the method of FIG. 2A. The method of FIG. 2B can be implemented by a device that receives audio signals from a device that implements the method of FIG. 2A. For example, the method of FIG. 2A can be performed by a sending participant device in a telecommunication session and the method of FIG. 2B could be performed by a receiving participant device, or any other suitable device, in the same telecommunication session. It is to be noted that a participant device can typically act as both a sending device and a receiving device within a telecommunication session. In some examples the method of FIG. 2B could be implemented by an apparatus or controller comprised within an audio rendering device or a telecommunications server or any other suitable type of device.

The method comprises, at block 210, receiving a spatial audio signal where the spatial audio signal represents an audio scene and at block 212 receiving spatial metadata corresponding to the spatial audio signal. The method also comprises, at block 214, receiving auxiliary audio signals where the auxiliary audio signals represent the audio scene and have been processed using a process different to a process used for the spatial audio signal. The method also comprises, at block 216, receiving an indication that the spatial metadata corresponding to the spatial audio signal can be reused for the auxiliary audio signal.

The spatial audio signal, spatial metadata, auxiliary audio signals and indication that the spatial metadata corresponding to the spatial audio signal can be reused for the auxiliary audio signals can be received from an encoding device or other suitable device that is implementing the method of FIG. 2A.

At block 218 the method also comprises, rendering the auxiliary audio signals using the metadata corresponding to the spatial audio signal. The decoding device can switch to rendering the auxiliary audio signals based on a signaling flag or any other suitable indication. The signaling flag can indicate that the auxiliary audio signals are available or can indicate any other suitable information.

In some examples the indication can comprise one or more adjustment parameters indicative of improvements or other adjustments to be made to the spatial metadata for use with the auxiliary audio signal. When the auxiliary audio signals are rendered the adjustments to the metadata corresponding to the spatial audio signal can be applied so that the adjusted spatial metadata can be used to render the auxiliary audio signal. The adjustments can provide improvements to the spatial metadata in that it can improve one or more perceptible qualities of the rendered audio for a user. In some examples a module or other means can be arranged to assess what improvements or other adjustments can be made to the spatial metadata.

In some examples the method of FIG. 2B could comprise sending a request for the auxiliary audio signals to an encoding device or any other suitable device within the telecommunication session. The request could be sent at any time during telecommunication session, for example, it could be included as part of a session negotiation or could be sent as a specific request once the telecommunication session has started. In some examples the request could be send in response to detecting a user input. For instance, during a telecommunication session a participant could decide that they want reduced background noise and so they can use any suitable user interface to request this.

The rendering of the auxiliary audio signals can enable a participant in the telecommunications session to select which processing is used for the audio signals that they are listening to. For example, they can indicate a preference for the auxiliary audio signals because this might have reduced background noise. Reusing the metadata corresponding to the spatial audio signal for rendering of the auxiliary audio signals provides for an efficient system because only one set of metadata needs to be provided to enable two different sets of spatial audio signals to be rendered.

Examples of the disclosure also enable different audio signals to be used by different participants within a telecommunication session. For example, a first receiving participant could listen to regular spatial audio with no optional processing applied, while a second receiving participant could listen to audio-focused spatial audio or audio that has been processed in any other suitable optional manner.

In examples of the disclosure the auxiliary audio signals can be transmitted using a lower overall bitrate (or same overall bitrate with better quality) that the spatial audio signals because they are provided without spatial metadata that is to be used for their rendering. Instead, an indication is provided that spatial metadata of the spatial audio signals can be reused. During rendering and playback, the spatial audio signals might be unused, but the corresponding metadata is used for rendering and playback of at least one auxiliary audio signal.

In some examples, the receiving device can provide feedback information to the sending device. The feedback information can provide an indication of which audio signal is being used or an expected importance of the respective audio signals. This information can be used for providing a specific bit allocation at the encoder.

FIGS. 3A and 3B show example use case scenarios for examples of the disclosure. FIGS. 3A and 3B show a participant 100 in a telecommunication session. The participant 100 can be using a participant device 102 to receive the audio signals and render the audio signals for playback by a playback device. The participant 100 can be listening to the audio from the telecommunication session using headphones or any other suitable playback device. FIGS. 3A and 3B could represent the same participant 100 at different times during a telecommunication session or could represent different participants. In FIG. 3A the participant 100 is listening to the spatial audio while in FIG. 3B the participant 100 is listening to the auxiliary audio.

The spatial audio signals and the auxiliary audio signals represent the same audio scene. The audio scene comprises a first person talking 300A, a second person talking 300B, some directional background sounds 302A, 302B and some ambient background noise 304.

The people talking 300A, 300B, can be participants in the telecommunication session. These could be people their own participant devices to participate in the telecommunication session. In the captured audio scene, the first person talking 300A is positioned behind the participant 100. When the spatial audio (or auxiliary audio) is rendered the participant 100 can perceive the speech from the first person 300A to come from behind them. Similarly, the second person talking 300B is positioned in front of the participant 100. When the spatial audio (or auxiliary audio) is rendered the participant 100 can perceive the speech from the second person 300B to come from in front of them.

The directional background sounds 302A, 302B can comprise sounds that can be perceived to come from a particular direction. The directional background sounds 302A, 302B can comprise sounds that are not key to the telecommunication session, for example they are not people talking to the participant 100 or are not providing information for or directly involved with the telecommunication session. The directional background sounds 302A, 302B could be car horns, engines revving or any other suitable sounds. The types of directional background sounds 302A, 302B would be dependent upon the location of the audio scene.

In the example of FIGS. 3A and 3B the directional background sounds 302A, 302B are both located on the left-hand side of the participant 100. The directional background sounds 302A, 302B could be located in any suitable position relative to the participant 100 and the number of them may vary.

The audio scene also comprises ambient background noise 304. The ambient background noise 304 comprises diffuse sounds that do not appear to come from any specific direction. The ambient background noise 304 is represented as the dashed line in FIG. 3A. the ambient background noise 304 surrounds the participant 100. The ambient background noise 304 can comprise traffic noise or any other suitable type of noise. The types of ambient background noise 304 would be dependent upon the location of the audio scene.

In the example of FIGS. 3A and 3B the participant 100 can indicate whether or not they want to hear the ambient background noise 304. In some circumstances the participant 100 might want to hear the ambient background noise 304. For example, it could provide pleasant background noise that contributes to the atmosphere of the audio. In some circumstances the participant 100 not might want to hear the ambient background noise 304. For example, it might be distracting, or it might make it difficult to hear the people talking 300A, 300B.

FIG. 3A shows the audio scene as would be rendered by the spatial audio signals. This comprises the first person talking 300A, the second person talking 300B, the directional background sounds 302A, 302B and the ambient background noise 304. FIG. 3B shows the spatial audio as would be rendered by the auxiliary audio signals. In this example the auxiliary audio signals have been processed to remove, or reduce, the ambient background noise 304. For example, a noise reduction could be applied to the auxiliary signals. This noise reduction is not applied, or is applied at a lower level, to the spatial audio signals. Therefore, the audio scene that is rendered in the example of FIG. 3B comprises the first person talking 300A, the second person talking 300B and the directional background sounds 302A, 302B but does not comprise the ambient background noise 304. This can make it easier for the participant 100 to hear or concentrate on the people talking 300A, 300B.

There can also be other difference between the spatial audio as would be provided by the auxiliary audio signals. For example, the directional background sounds 302A, 302B could be provided at a lower intensity or level in the auxiliary signals compared to the spatial audio signals.

In implementations of the disclosure the participant 100 could initially be listening to the spatial audio as shown in FIG. 3A. The participant 100 could then decide that they would prefer to listen to the auxiliary audio as shown in FIG. 3B. For example, the participant 100 could decide that they find the ambient background noise 304 distracting, or they might find it difficult to hear the people talking 300A, 300B. In such cases the participant 100 could make an input via their participant device 102 requesting the auxiliary audio signals. This request could be sent to an encoder device or any other suitable device within a telecommunication session.

In other examples it could be determined automatically (without a specific user input) that the auxiliary audio signals should be provided. For example, a module can monitor the spatial audio signals and can determine if the ambient background noise 304 has exceeded a threshold. The threshold could be a fixed threshold or could be relative to the people talking 300A, 300B or other direction sound sources. If the module determines that the ambient background noise is above a given level, then this can trigger the providing of the auxiliary audio signals. Other trigger events for providing the auxiliary audio signals could be used in other examples.

In examples where a module is used to monitor the spatial audio signals the module can determine if the ambient background noise 304 has exceeded a threshold. The module can be implemented in any suitable device such as an encoding device.

In examples of the disclosure the auxiliary audio signals are provided if the appropriate trigger conditions are satisfied. The trigger conditions can be the receiving of a request from the participant 100. In some examples the trigger condition could be a determination that the ambient background noise 304 has exceeded a threshold or any other suitable trigger condition.

In examples of the disclosure two audio signals are provided. The first is the spatial audio signal that enables an audio scene as shown in FIG. 3A to be rendered and the second is the auxiliary audio signals that enables an audio scene as shown in FIG. 3B to be rendered. The auxiliary audio signals can be obtained by using a different process to the process used for the spatial audio signal. In this case noise reduction to remove the ambient background noise 304 is not applied to the spatial audio signal but is applied to the auxiliary audio signal. In some examples a small amount of noise reduction could be applied to the spatial audio signal and a higher amount of noise reduction could be applied to the auxiliary audio signal. Other types of process can be applied to the respective signals in other examples.

Both the spatial audio signal and the auxiliary audio signals are provided to the participant device 102. The spatial audio signal and the auxiliary audio signals are transmitted with spatial metadata that corresponds to the spatial audio signal. That is, the spatial metadata is shared for both the spatial audio signal and the auxiliary audio signals so that only a single set of spatial metadata is sent for both the spatial audio signal and the auxiliary audio signals. An indication is also provided indicating that the spatial metadata corresponding to the spatial audio signal can be reused for the auxiliary audio signals.

In some examples a MASA format and IVAS codec can be used. In such examples the spatial audio signal could comprise a stereo-MASA signal. The stereo-MASA signal can comprise two transport channels and corresponding MASA metadata. The auxiliary audio signals can comprise a stereo signal. The stereo signal can comprise two transport channels and an indication that indicates that the spatial metadata corresponding to the spatial audio signal can be reused for the auxiliary audio signal. This avoids the duplication of the spatial metadata and so provides bitrate savings. This can enable better audio quality to be achieved because of the efficiencies in bitrate.

In some examples the spatial audio signal could comprise a stereo-MASA signal and the auxiliary audio signals can comprise a mono signal. This can provide for a more efficient use of bitrate. In some examples the respective spatial audio signals can be allocated different bitrates for encoding so as to optimize, or substantially optimize, the bit budget. Any suitable criteria can be used for the allocation of the bitrates.

In the example shown in FIGS. 3A and 3B there are two different audio streams provided. In other examples there can be more than two audio streams. For instance, a spatial audio signal can be provided and multiple auxiliary audio signals could also be provided. The multiple auxiliary audio signals could be processed using different processes and/or using different amounts of processing. The different types of processes that are applied could comprise wind noise reduction, ambient background noise reduction, audio focusing or any other suitable type of process.

In such examples an indication can be provided indicating which of the auxiliary audio signals can be rendered using the spatial metadata corresponding to the spatial audio signal. An indication can also be provided indicating the type of auxiliary audio stream that is being provided. This could indicate the type of process that has been used and the amount of the process that has been used. The respective indications can be provided using Processing Information (PI) data frames or any other suitable information.

In some examples the indication can comprise one or more adjustment parameters. The adjustment parameters can indicate adjustments or other improvements to be made to the spatial metadata for use with the auxiliary audio signal. The adjustments can account for differences in the respective audio signals resulting from the different processes that have been used. The adjustment enable the spatial metadata to be reused with some changes or improvements made where appropriate.

In some examples the auxiliary audio signals can be provided whenever the appropriate trigger conditions are satisfied. This can enable dynamic or time varying provision of the auxiliary audio signals. That is, the auxiliary audio signals can be provided at times when the trigger conditions are satisfied and are not provided at times when the trigger conditions are not satisfied. For example, the trigger condition could be that the ambient background noise 304 is detected to be above a certain level. In such cases, when the ambient background noise 304 is detected then the auxiliary audio signals are provided and when the ambient background noise 304 is not detected or is below a threshold level the auxiliary audio signals are not provided. In some examples the participant 100 could make an input to enable switching between the respective audio signals. A setting or flag can be used to indicate that one or more auxiliary audio signals are to be provided.

In some examples there could be some mixing of the spatial audio signals and the one or more auxiliary audio signals. The mixing of the signals can be controlled to provide for adjustable background noise levels, or other types of processing. For example, instead of using either the spatial audio signal or the auxiliary audio signals for playback a mix of the signals could be used. The level of mixing could be adjustable, for example, in response to a user input. Controlling the level of mixing can comprise controlling the relative weightings of the spatial audio signal or the auxiliary audio signals that are used for playback. These could be adjusted in response to a user input so as to enable a user to adjust the level of processing in the audio they hear.

FIG. 4 shows an example system 400 that could be used to implement examples of the disclosure. In this example the processing that is applied to the auxiliary audio signals is wind noise reduction (WNR). Other types of processing can be used in other examples.

The example of FIG. 4 uses an IVAS codec with Real-time Transport Protocol (RTP) payload support using Processing Information (PI) data frames. Other types of codec can be used in other examples. PI data frames or other means for providing side information can be used with codecs other than IVAS codecs.

The system 400 comprises an audio capture module 402. The audio capture module 402 is configured to obtain microphone signals from microphones 104 and provide audio signals as an output. The audio signals can comprise spatial audio signals. The audio capture module 402 can apply different processes to the microphone signals to provide a spatial audio signal 404 and an auxiliary audio signal 406. The spatial audio signal 404 and the auxiliary audio signal 406 can represent the same sound scene but the auxiliary audio signal 406 is processed using a process different to a process used for the spatial audio signal 404. In this case WNR is used on the auxiliary audio signal 406 but not the spatial audio signal. Other type of processing could be used in other examples.

The audio capture module 402 provides the respective spatial audio signals 404, 406 as outputs. In this case the spatial audio signal 404 comprises a MASA signal. This comprises transport channel and spatial metadata. The auxiliary audio signal 406 is a stereo signal with applied WNR. This auxiliary audio signal 406 does not comprise spatial metadata.

The audio capture module 402 also provides side information 408 as an output. The side information 408 can comprise an indication that the spatial metadata corresponding to the spatial audio signal 404 can be reused for the auxiliary audio signal 406. The side information 408 could also comprise additional information such as the type of processing that has been applied to the auxiliary audio signal 406 or any other suitable information.

The spatial audio signal 404, the auxiliary audio signal 406 and the side information 408 are provided as inputs to an encoder 410. The encoder 410 is configured to encode the spatial audio signal 404 and the auxiliary audio signal 406. The encoder 410 can be an IVAS encoder or any other suitable type of encoder.

The encoder 410 provides coded frames 412 and a PI data frame 414 as an output. The coded frames 412 can comprise the encoded spatial audio signal 404, including the spatial metadata, and the encoded auxiliary audio signal 406. These can be encoded into the same bitstream or into different bitstreams.

The PI data frame 414 can comprise the indication that the spatial metadata corresponding to the auxiliary audio signal 406 can be reused for the auxiliary audio signal.

The coded frames 412 and the PI data frame 414 are provided to an RTP packetization module 416. The RTP packetization module 416 configures the coded frames 412 and the PI data frame 414 into packets 418 for transmission. The packets 418 can be transmitted use any suitable wired and/or wireless communication network.

The packets 418 can be transmitted from an encoding device to a decoding device or any other suitable device within the communication network.

The received packets are provided to an RTP de-packetization module 420. The RTP de-packetization module 420 provides the coded frames and PI data frames 422 as an output. The coded frames and PI data frames 422 are provided to a decoder 424. The decoder 424 is configured to decode the received frames and render them for playback. If an indication that the spatial metadata corresponding to the spatial audio signal 404 can be reused for the auxiliary audio signal 406 is provided, then the same spatial metadata can be used for rendering both the spatial audio signal 404 and the auxiliary audio signal 406.

In some examples some adjustments or improvements can be made to the spatial metadata before it is reused for the auxiliary audio signal 406. The adjustments or improvements can take into account any effects of the processing that has been used for the auxiliary audio signal 406.

The decoder 424 provides rendered audio signals as an output. In this example the decoder 424 provides a MASA signal 426. This corresponds to the spatial audio signals 404 and comprises the spatial metadata. The decoder 424 also provides a MASA signal with WNR 428. This corresponds to the auxiliary audio signal 406. The spatial metadata of the spatial audio signals 404 is shared with the auxiliary audio signal 406 to enable the MASA signal with WNR 428. That is, the decoder 424 can generate two different MASA signals even though only one set of spatial metadata was provided from the encoding device.

The decoder 424 can comprise multiple decoder instances. For example, a first decoder instance can be used to decode the spatial audio signal 404 and the spatial metadata. The metadata can then be used by another decoder instance to decode the auxiliary audio signal 406.

The MASA signal 426 and the MASA signal with WNR 428 are provided to the playback module 430. The playback module 430 can playback one of the MASA signal 426 and the MASA signal with WNR 428 or can playback a mix of the respective signals.

FIG. 5 shows an example decoder 424 that can be used in examples of the disclosure.

The RTP packets 418 are received from the encoding device and provided to an RTP de-packetization module 420. The RTP de-packetization module 420 provides coded frames and PI data frames 422 as an output.

The coded frames and PI data frames 422 are provided to a network jitter analysis module 500. The network jitter analysis module 500 can estimate any delays within the communication network and perform target delay estimation. The network jitter analysis module 500 can provide a target delay estimate 502 as an output. The target delay estimate can be provided as an input to adaptation control logic 504. The adaptation control logic 504 can be configured to control the timings of the respective audio signals.

The coded frames and PI data frames 422 are also provided to a de-jitter buffer 506. The de-jitter buffer can temporally store frames so as to reduce jitter in the output audio. The de-jitter buffer 506 can receive a control signal 508 from the adaptation control logic 504 to control the storage of the frames.

The de-jitter buffer 506 provides an output 510 to the decoder 424. The output 510 comprises the coded frames and the PI data frames or any other suitable side information. The decoder 424 comprises a first decoder instance 512A and a second decoder instance 512B. The output 510 from the de-jitter buffer 506 is provided to the first decoder instance 512A and a second decoder instance 512B. The first decoder instance 512A can be used to decode the spatial audio signal 404 and the second decoder instance 512B can be used to decode the auxiliary audio signal 406. The respective decoder instances 512A, 512B can operate in parallel. Multiple decoder instances 512A, 512B are used so that the spatial metadata can be obtained by decoding the spatial audio signal 404 and can then be reused for rendering any auxiliary audio signals 406. The multiple decoder instances can share a renderer or could comprise separate renderers.

The decoder instances comprise an IVAS bitstream decoding module 514A, 514B and a time scale modification module 516A, 516B. The respective decoder instances 512A, 512B provide decoded signals 518A, 518B as an output.

The bitstream decoding can also comprise rendering of the spatial audio signals.

The decoder 424 also comprises a side information handling module 520. The output 510 from the de-jitter buffer 506 is also provided to the side information handling module 520. The side information handling module 520 can be configured to determine if any side information indicates that the spatial metadata for the spatial audio signal can be reused for the auxiliary audio signal. Based on whether there is an indication that the side information handling module 520 can provide control signals to the respective decoder instances 512A, 512B so that the spatial metadata can be reused. This enable the spatial metadata from the spatial audio signal 404 to be reused for the auxiliary audio signal and so generates a second MASA signal.

In FIG. 5 the time scale modification module 516A of the first decoder instance 512A is shown as providing an input 524 to a playout delay estimation module 522 and receiving a control signal 526 from the adaptation control logic 504. Corresponding signals would also be exchanged between the time scale modification module 516B of the second decoder instance 512B and the playout delay estimation module 522 and the adaptation control logic 504. These signals are not shown in FIG. 5 for clarity.

The playout delay estimation module 522, adaptation control logic 504 and timescale modification modules 516 can ensure that signals are correctly synchronized.

The decoded signals 518A, 518B are provided to a receiver output buffer 528. The receiver output buffer 528 provides an output signal 530 that can be provided to a playback device. The output signal 530 can comprise a pulse code modulated (PCM) signal or any other suitable type of signal.

Whether or not the encoders and decoders comprise multiple instances can depend upon the type of codecs that are used. Some codecs can support coding of multiple simultaneous audio inputs such as MASA and stereo together. In examples where such codecs are used the encoder only needs to define a new side information that indicates that the spatial metadata of a first audio input can be reused for the second audio input.

Current IVAS codecs does not support coding of multiple simultaneous audio inputs such as MASA and stereo together. Therefore, in examples that use IVAS multiple encoder instances would be used. Transmission of the encoded signals can be achieved using multiple RTP streams in a session.

In some examples support of multi-streaming in an IVAS session can be enabled. The multi-streaming can comprise sending multiple IVAS streams in the same RTP payload. This can be enabled by using a suitable extension of PI data frames to identify it. This approach enables easy synchronization between different IVAS streams, as the payload includes all the audio bitstreams and side information that are required for correct, synchronous rendering. This extension of the PI data frames can use streamID fields. The streamID fields can be unique numerical identifiers for the session, unique null-terminated strings, or any such suitable values that identify the different streams from each other. N_ToC fields can indicate the number of ToC (table of contents) bytes associated with each stream. In some examples, the PI data frame only indicates the presence of multiple IVAS streams. The number of streams can be determined by counting the ToC bytes (each ToC byte corresponding to an independent or different IVAS stream).

The side information that is transmitted can comprise the indication that the spatial metadata can be reused for the auxiliary audio streams. The side information can be provided in different way. The manner in which the side information is provided can be determined by the type of codec used. In some examples the side information can be provided as part of the codec bitstream. In some examples the side information can be provided through the use of a new PI data frame. The new PI data frame could be referred to as a REUSE_METADATA PI data frame.

The REUSE_METADATA PI data frame could be implemented in any suitable manner. As an example, three input audio streams could be provided. These could comprise a first spatial audio signal with corresponding spatial metadata and two auxiliary audio signals. The respective input audio streams can have streamID values ID1, ID2, and ID3. The multi-streaming can be implemented in any suitable way. In this case ID1 corresponds to the spatial audio signal. This can be a signal that has not been processed to remove background noise for example or it might not have had other types of optional processing applied to it. ID2 and ID3 correspond to the auxiliary audio signals. Some optional processing has been applied to the auxiliary audio signals that has not been applied to the spatial audio signal. In this case ID2 corresponds to a stereo input that has WNR applied and ID3 corresponds to a mono input that has noise suppression applied. Other types of signals and processing can be used in other examples.

The REUSE_METADATA PI data frame can therefore indicate, not just if the spatial metadata can be reused but for which of the input audio streams and auxiliary audio signals the spatial metadata can be reused.

An example REUSE_METADATA PI data frame is shown below,

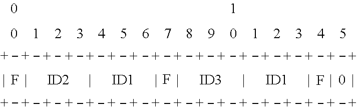

In this example the F-bit indicates whether another ID field follows or not. For example, for ID2 the F-bit is set to 1. This indicates that another ID field follows). For ID3 the F-bit is set to 0. This indicates that ID3 is the last ID field in the REUSE_METADATA PI data frame. The REUSE_METADATA PI data frames can be zero-padded to force byte-alignment, as shown above.

The side information can also comprise adjustment parameters for the spatial metadata. The adjustments can comprise corrections or other adjustments that can be used to account for any changes caused by the processing applied to the auxiliary audio signals. For example, if the REUSE_METADATA PI data frame shown above is used to reduce ambient background noise 304 as shown in FIGS. 3A and 3B then the adjustment parameters can comprise adjustments to the transmitted direct-to-total energy ratio values that take into account the loss of energy relating to the noise suppression in certain TF tiles. The adjustment parameters can indicate how the direct-to-total energy ratio values can be boosted.

The adjustment parameters can be specific to an auxiliary audio signal. In this example the adjustment parameters can be used for the third stream that has had noise reduction applied but would not be used for the second stream that has had wind noise reduction applied. The REUSE_METADATA PI data frame can indicate which streams the adjustment parameters are to be used for.

Examples of the disclosure can be implemented using any suitable formats. In some examples the format could comprise Objects with MASA (OMASA). OMASA is supported by the IVAS standard. In this case the spatial metadata that is reused between respective spatial audio signals can be object metadata. In such examples the auxiliary audio signals can comprise speech objects with different language versions.

IVAS can have two directions in each time-frequency tile as described in. In next generation codecs metadata could be added describing if the first and second direction have a fixed meaning. With respect to this disclosure, one of the directions could be reserved for the auxiliary audio signals and the other to the spatial audio signal. Alternatively, both directions could be used for the spatial audio signal and their order could be such that either the first or second of the directions is always used for the auxiliary audio signal.

FIG. 6 schematically illustrates an apparatus 600 that can be used to implement examples of the disclosure. In this example the apparatus 600 comprises a controller 602. The controller 602 can be a chip or a chipset. In some examples the controller 602 can be provided within a participant device 102, an encoding device, e decoding device, a rendering device or a teleconferencing server or any other suitable type of device.

In the example of FIG. 6 the implementation of the controller 602 can be as controller circuitry. In some examples the controller 602 can be implemented in hardware alone, have certain aspects in software including firmware alone or can be a combination of hardware and software (including firmware).

As illustrated in FIG. 6 the controller 602 can be implemented using instructions that enable hardware functionality, for example, by using executable instructions of a computer program 608 in a general-purpose or special-purpose processor 604 that can be stored on a computer readable storage medium (disk, memory etc.) to be executed by such a processor 604.

The processor 604 is configured to read from and write to the memory 606. The processor 604 can also comprise an output interface via which data and/or commands are output by the processor 604 and an input interface via which data and/or commands are input to the processor 604.

The memory 606 is configured to store a computer program 608 comprising computer program instructions (computer program code 610) that controls the operation of the controller 602 when loaded into the processor 604. The computer program instructions, of the computer program 608, provide the logic and routines that enables the controller 602 to perform the methods illustrated in the Figs. The processor 604 by reading the memory 606 is able to load and execute the computer program 608.

The apparatus 600 therefore comprises: at least one processor 604; and at least one memory 606 including computer program code 610, the at least one memory 606 and the computer program code 610 configured to, with the at least one processor 604, cause the apparatus 600 at least to perform:
providing 200 a spatial audio signal where the spatial audio signal represents an audio scene;
providing 202 spatial metadata corresponding to the spatial audio signal;
providing 204 auxiliary audio signals where the auxiliary audio signals represent the audio scene and have been processed using a process different to a process used for the spatial audio signal; and
providing 206 an indication that the spatial metadata corresponding to the spatial audio signal can be reused for the auxiliary audio signals.

The apparatus 600 therefore comprises: at least one processor 604; and at least one memory 606 including computer program code 610, the at least one memory 606 and the computer program code 610 configured to, with the at least one processor 604, cause the apparatus 600 at least to perform:
receiving 210 a spatial audio signal where the spatial audio signal represents an audio scene;
receiving 212 spatial metadata corresponding to the spatial audio signal;
receiving 214 auxiliary audio signals where the auxiliary audio signals represent the audio scene and have been processed using a process different to a process used for the spatial audio signal;
receiving 216 an indication that the spatial metadata corresponding to the spatial audio signal can be reused for the auxiliary audio signals; and
rendering 218 the auxiliary audio signals using the spatial metadata corresponding to the spatial audio signal.

As illustrated in FIG. 6 the computer program 608 can arrive at the controller 602 via any suitable delivery mechanism 612. The delivery mechanism 612 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 608. The delivery mechanism 612 can be a signal configured to reliably transfer the computer program 608. The controller 602 can propagate or transmit the computer program 608 as a computer data signal. In some examples the computer program 608 can be transmitted to the controller 602 using a wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol.

The computer program 608 comprises computer program instructions that when executed by an apparatus 600 cause the apparatus 600 to perform at least the following:
providing 200 a spatial audio signal where the spatial audio signal represents an audio scene;
providing 202 spatial metadata corresponding to the spatial audio signal;
providing 204 auxiliary audio signals where the auxiliary audio signals represent the audio scene and have been processed using a process different to a process used for the spatial audio signal; and
providing 206 an indication that the spatial metadata corresponding to the spatial audio signal can be reused for the auxiliary audio signals.

The computer program 608 comprises computer program instructions that when executed by an apparatus 600 cause the apparatus 600 to perform at least the following:
receiving 210 a spatial audio signal where the spatial audio signal represents an audio scene;
receiving 212 spatial metadata corresponding to the spatial audio signal;
receiving 214 auxiliary audio signals where the auxiliary audio signals represent the audio scene and have been processed using a process different to a process used for the spatial audio signal;
receiving 216 an indication that the spatial metadata corresponding to the spatial audio signal can be reused for the auxiliary audio signals; and
rendering 218 the auxiliary audio signals using the spatial metadata corresponding to the spatial audio signal.

The computer program instructions can be comprised in a computer program 608, a non-transitory computer readable medium, a computer program product, a machine readable medium. In some but not necessarily all examples, the computer program instructions can be distributed over more than one computer program 608.

Although the memory 606 is illustrated as a single component/circuitry it can be implemented as one or more separate components/circuitry some or all of which can be integrated/removable and/or can provide permanent/semi-permanent/dynamic/cached storage.

Although the processor 604 is illustrated as a single component/circuitry it can be implemented as one or more separate components/circuitry some or all of which can be integrated/removable. The processor 604 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software can not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The apparatus 600 as shown in FIG. 6 can be provided within any suitable device. In some examples the apparatus 600 can be provided within an electronic device such as a mobile telephone, a teleconferencing device, a camera, a computing device, a server or any other suitable device.

The blocks illustrated in the Figs. can represent steps in a method and/or sections of code in the computer program 608. The illustration of a particular order to the blocks does not necessarily imply that there is a required or preferred order for the blocks and the order and arrangement of the blocks can be varied. Furthermore, it can be possible for some blocks to be omitted.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning, then it will be made clear in the context by referring to ‘comprising only one . . . ’ or by using ‘consisting.’

In this description, the wording ‘connect’, ‘couple’ and ‘communication’ and their derivatives mean operationally connected/coupled/in communication. It should be appreciated that any number or combination of intervening components can exist (including no intervening components), i.e., to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database, or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’, or ‘may’ refers to a particular instance in a class of examples. A property of the instance can be a property of only that instance or a property of the class or a property of a sub-class of the class that includes some but not all the instances in the class. It is therefore implicitly disclosed that a feature described with reference to one example but not with reference to another example, can where possible be used in that other example as part of a working combination but does not necessarily have to be used in that other example.

As used herein, “at least one of the following:” and “at least one of” and similar wording, where the list of two or more elements are joined by “and” or “or” mean at least any one of the elements, or at least any two or more of the elements, or at least all the elements.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

The description of a feature, such as an apparatus or a component of an apparatus, configured to perform a function, or for performing a function, should additionally be considered to also disclose a method of performing that function. For example, description of an apparatus configured to perform one or more actions, or for performing one or more actions, should additionally be considered to disclose a method of performing those one or more actions with or without the apparatus.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance the Applicant may seek protection via the claims in respect of any patentable feature or combination of features hereinbefore referred to and/or shown in the drawings whether or not emphasis has been placed thereon.

1-23. (canceled)

24. An apparatus comprising:
at least one processor; and
at least one memory storing instructions that, when executed by the at least one processor, cause the apparatus at least to:
provide a spatial audio signal where the spatial audio signal represents an audio scene;
provide spatial metadata corresponding to the spatial audio signal;
provide at least one auxiliary audio signal where the at least one auxiliary audio signal represents the audio scene and have been processed using a process different from a process used for the spatial audio signal; and
provide an indication that the spatial metadata corresponding to the spatial audio signal can be reused for the at least one auxiliary audio signal.

25. An apparatus as claimed in claim 24, wherein the different process used for the at least one auxiliary audio signal comprises a different type of processing to the process used for the spatial audio signal.

26. An apparatus as claimed in claim 24, wherein the different process used for the at least one auxiliary audio signal comprises a different amount of processing to the process used for the spatial audio signal.

27. An apparatus as claimed in claim 24, wherein the process for the at least one auxiliary audio signal comprises at least one of:
noise reduction;
wind noise reduction; or
audio focusing.

28. An apparatus as claimed in claim 24, wherein the at least one auxiliary audio signal is provided in response to a trigger event wherein the trigger event comprises at least one of:
receiving a request for the at least one auxiliary audio signal from a receiving device; or
determining that one or more trigger conditions are satisfied.

29. An apparatus as claimed in claim 24, wherein the indication comprises one or more adjustment parameters indicative of adjustments to be made to the spatial metadata for use with the at least one auxiliary audio signal.

30. An apparatus as claimed in claim 24, wherein the indication is provided as at least one of:
a processing information data frame; or
part of a bitstream.

31. An apparatus as claimed in claim 24, wherein the apparatus is further caused to provide multiple auxiliary audio signals wherein respective auxiliary audio signals are processed using different processes.

32. An apparatus as claimed in claim 31, wherein different auxiliary audio signals are provided for different participants in a telecommunication session.

33. An apparatus as claimed in claim 24, wherein the spatial audio signal and the spatial metadata are provided by a first encoder and the at least one auxiliary audio signal is provided by a second encoder.

34. An apparatus as claimed in claim 24, wherein the spatial audio signal is provided as a metadata-assisted spatial audio signal.

35. An apparatus as claimed in claim 24, wherein the spatial audio signal and the spatial metadata, the at least one auxiliary audio signal and the indication are provided in a shared bitstream.

36. An apparatus as claimed in claim 24, wherein the apparatus is comprised within at least one of:
an audio capturing device; or
a telecommunications server.

37. A method comprising:
providing a spatial audio signal where the spatial audio signal represents an audio scene;
providing spatial metadata corresponding to the spatial audio signal;
providing at least one auxiliary audio signal where the at least one auxiliary audio signal represents the audio scene and have been processed using a process different to a process used for the spatial audio signal; and
providing an indication that the spatial metadata corresponding to the spatial audio signal can be reused for the at least one auxiliary audio signal.

38. An apparatus comprising:
at least one processor; and
at least one memory storing instructions that, when executed by the at least one processor, cause the apparatus at least to:
receive a spatial audio signal where the spatial audio signal represents an audio scene;
receive spatial metadata corresponding to the spatial audio signal;
receive at least one auxiliary audio signal where the at least one auxiliary audio signal represents the audio scene and have been processed using a process different to a process used for the spatial audio signal;
receive an indication that the spatial metadata corresponding to the spatial audio signal can be reused for the at least one auxiliary audio signal; and
render the at least one auxiliary audio signal using the spatial metadata corresponding to the spatial audio signal.

39. An apparatus as claimed in claim 38, wherein the apparatus is further caused to send a request for the at least one auxiliary audio signal to an encoding device.

40. An apparatus as claimed in claim 39, wherein the request is sent in response to detecting a user input.

41. An apparatus as claimed in claim 38, wherein the indication comprises one or more adjustment parameters indicative of improvements to be made to the spatial metadata for use with the at least one auxiliary audio signal and the apparatus is further caused to apply the improvements to the spatial metadata corresponding to the spatial audio signal and use the adjusted spatial metadata to render the at least one auxiliary audio signal.

42. An apparatus as claimed in claim 38, wherein the apparatus is comprised within at least one of:
an audio rendering device; or
a telecommunications server.
